(19) United States
(12) Patent Application Publication
(10) Pub. No.: US 2018/0089020 A1
(43) Pub. Date: Mar. 29, 2018

(54) MANAGING REBUILDING PERFORMANCE IN A DISPERSED STORAGE NETWORK

(71) Applicant: International Business Machines Corporation, Armonk, NY (US)

(72) Inventors: Ravi V. Khadiwala, Bartlett, IL (US); Jason K. Resch, Chicago, IL (US)

(21) Appl. No.: 15/824,496

(22) Filed: Nov. 28, 2017

Related U.S. Application Data
(63) Continuation-in-part of application No. 15/249,905, filed on Aug. 29, 2016.
Application No. 15/249,905 is a continuation of application No. 14/256,472, filed on Apr. 18, 2014, now Pat. No. 9,432,341.
(60) Provisional application No. 61/828,905, filed on May 30, 2013.

(51) Int. Cl. G06F 11/10; H04L 29/06; H04L 29/08; G06F 21/60; G06F 21/80; G06F 11/20; H04L 1/00

(52) U.S. Cl. CPC G06F 11/1004; H04L 1/0047; G06F 11/1076; H04L 63/062; H04L 63/061; H04L 63/0457; H04L 67/1097; G06F 11/1092; G06F 11/1096; G06F 21/602; G06F 21/80; G06F 11/2094; G06F 2211/1028; G06F 2221/2107; H04L 1/0042; H04L 69/14

(57) ABSTRACT

A method for execution by a rebuilding module includes identifying at least one dispersed storage network (DSN) address range associated with rebuilding operations performed by other rebuilding modules of the DSN. When the at least one DSN address range compares favorably with DSN address range data that includes a first DSN address range associated with rebuilding operations performed by the rebuilding module, a second DSN address range is selected from a plurality of DSN address ranges, and the DSN address range data is updated to include the first DSN address range and the second DSN address range. When the at least one DSN address range compares unfavorably with the first DSN address range, a third DSN address range is selected from the plurality of DSN address ranges, and the DSN address range data is updated by substituting the first DSN address range with the third DSN address range.

### CROSS-REFERENCE TO RELATED APPLICATIONS

The present U.S. Utility Patent Application claims priority pursuant to 35 U.S.C. § 120 as a continuation-in-part of U.S. Utility application Ser. No. 15/249,905, entitled “SECURING DATA IN A DISPERSED STORAGE NETWORK”, filed Aug. 29, 2016, which is a continuation of U.S. Utility application Ser. No. 14/256,472, entitled “SECURING DATA IN A DISPERSED STORAGE NETWORK”, filed Apr. 18, 2014, issued as U.S. Pat. No. 9,432,341 on Aug. 30, 2016, which claims priority pursuant to 35 U.S.C. § 119(e) to U.S. Provisional Application No. 61/828,905 entitled “ENCRYPTED ZERO INFORMATION GAIN DATA REBUILDING”, filed May 30, 2013, all of which are hereby incorporated herein by reference in their entirety and made part of the present U.S. Utility Patent Application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of an embodiment of a dispersed or distributed storage network (DSN) in accordance with the present invention;

FIG. 9B is a schematic block diagram of an embodiment of a dispersed or distributed storage network (DSN) in accordance with the present invention; and

FIG. 10 is a logic diagram of an example of a method of managing rebuilding performance in accordance with the present invention.

### DETAILED DESCRIPTION OF THE INVENTION

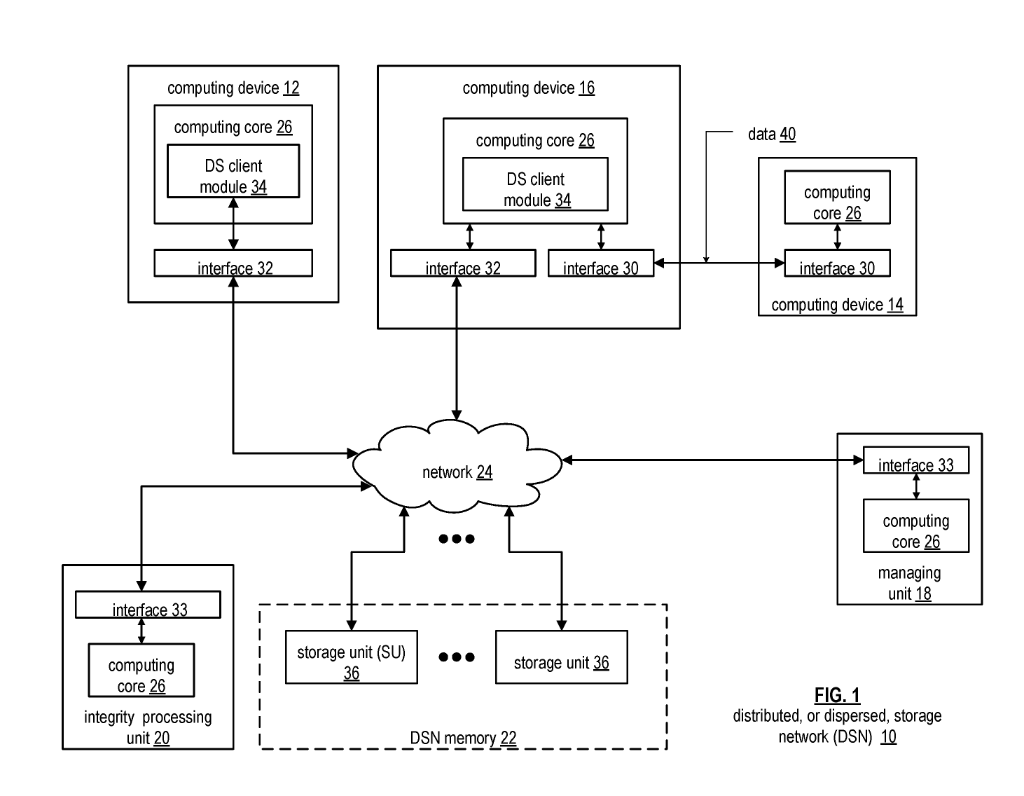

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public interne systems; and/or one or more local area networks (LAN) and/or wide area networks (WAN).

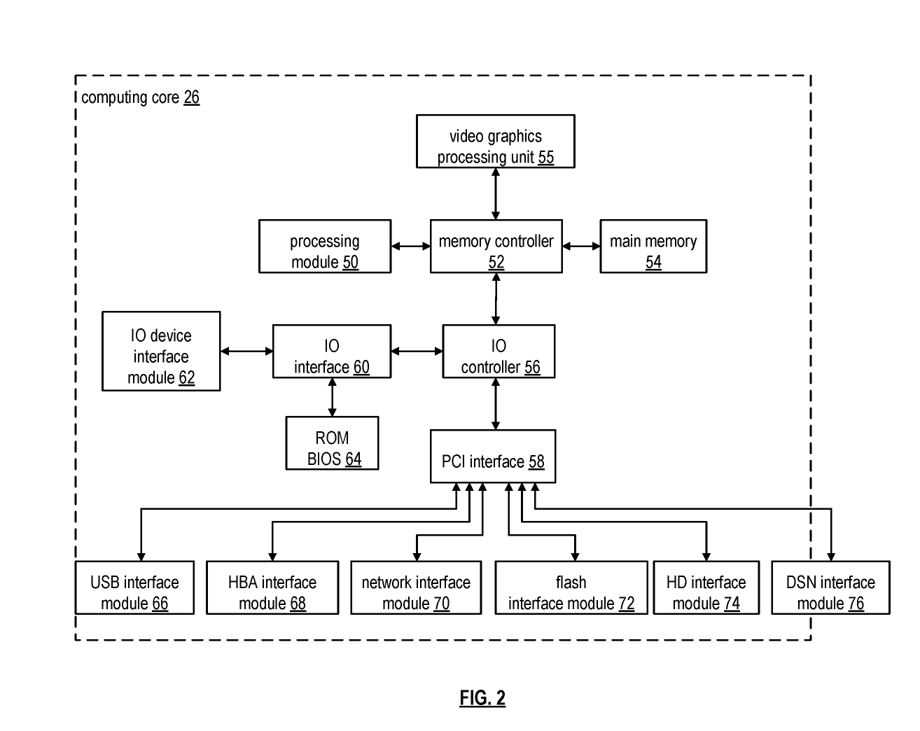

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

In various embodiments, each of the storage units operates as a distributed storage and task (DST) execution unit, and is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc. Hereafter, a storage unit may be interchangeably referred to as a dispersed storage and task (DST) execution unit and a set of storage units may be interchangeably referred to as a set of DST execution units.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each managing unit 18 and the integrity processing unit 20 may be separate computing devices, may be a common computing device, and/or may be integrated into one or more of the computing devices 12-16 and/or into one or more of the storage units 36. In various embodiments, computing devices 12-16 can include user devices and/or can be utilized by a requesting entity generating access requests, which can include requests to read or write data to storage units in the DSN.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

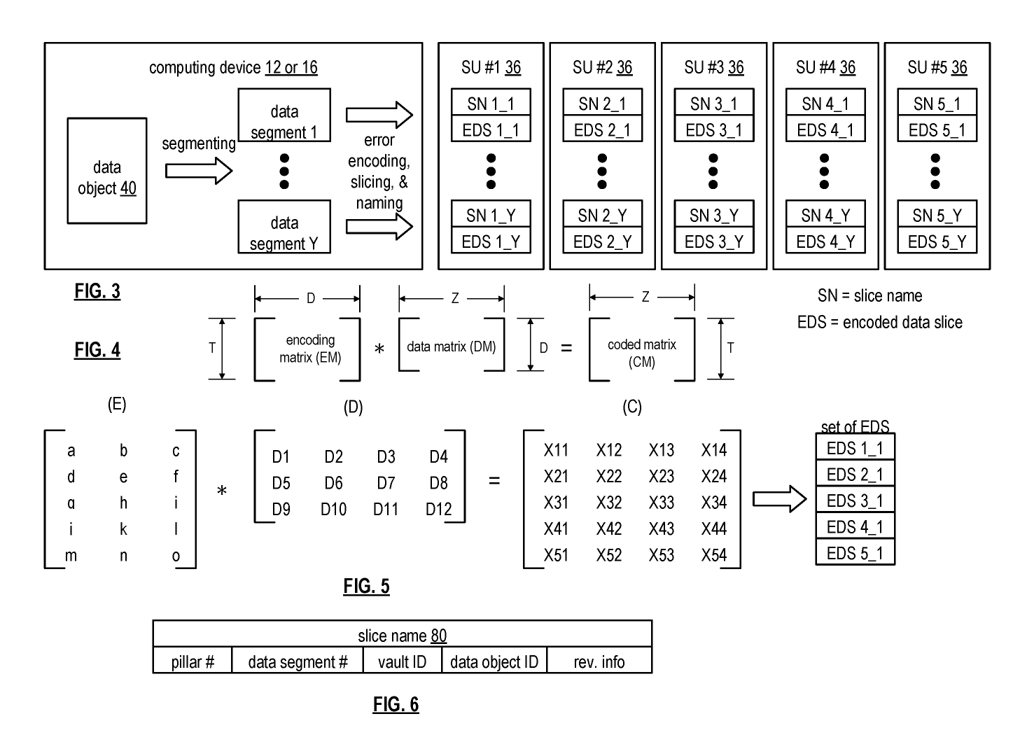

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (10) controller 56, a peripheral component interconnect (PCI) interface 58, an 10 interface module 60, at least one 10 device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the 10 device interface module 62 and/or the memory interface modules 66-76 may be collectively or individually referred to as 10 ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. Here, the computing device stores data object 40, which can include a file (e.g., text, video, audio, etc.), or other data arrangement. The dispersed storage error encoding parameters include an encoding function (e.g., information dispersal algorithm (IDA), Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides data object 40 into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_{—1}), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

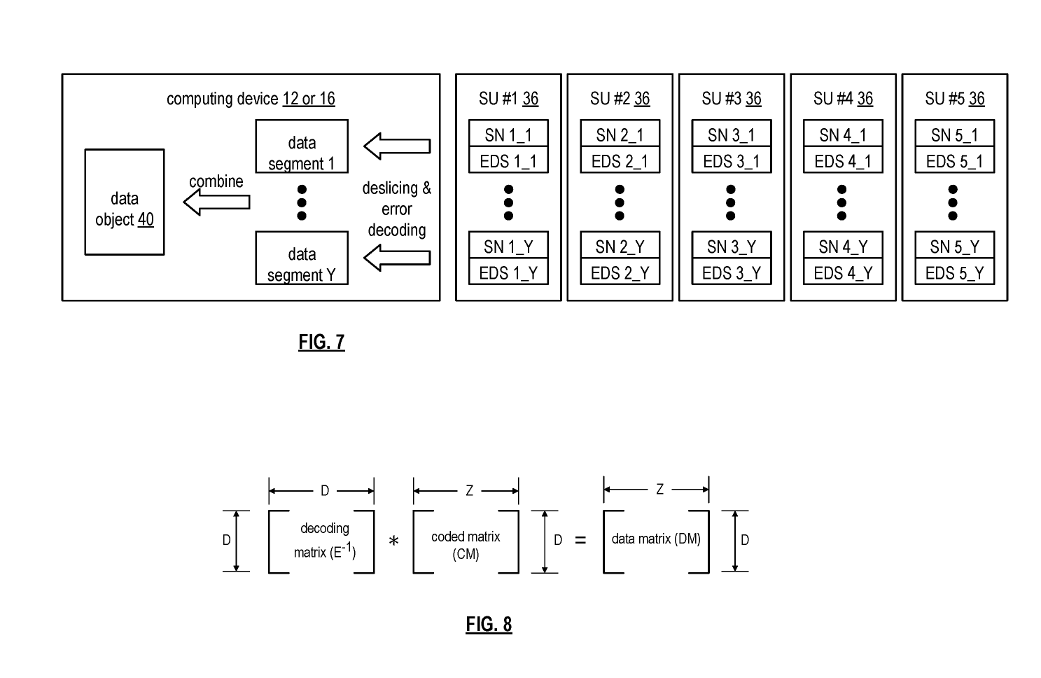

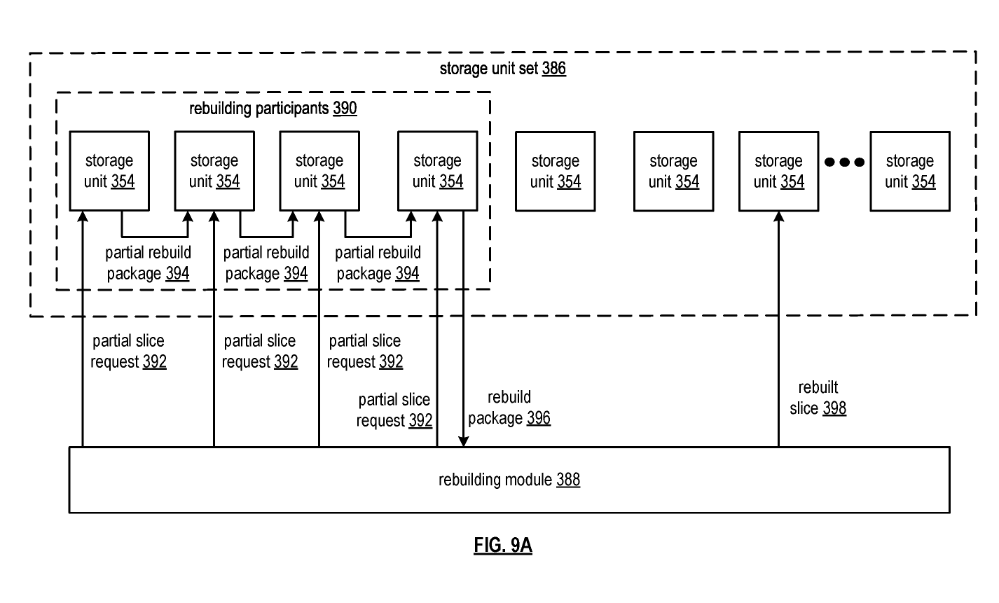

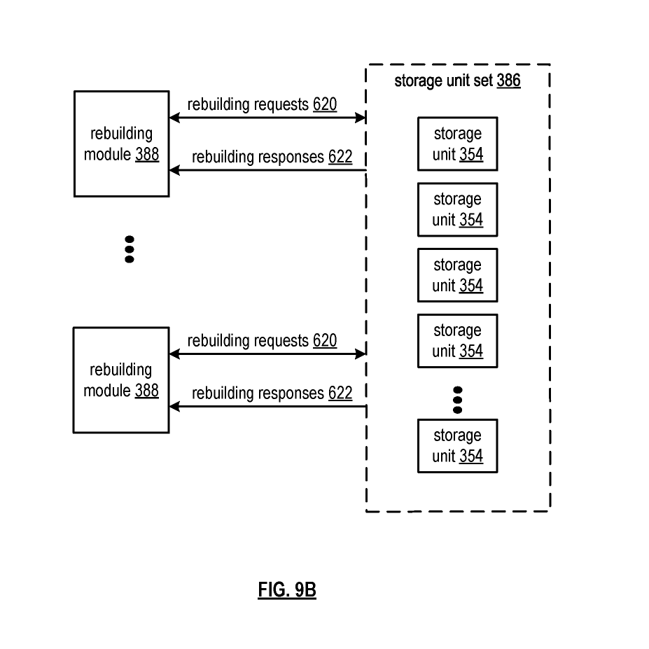

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

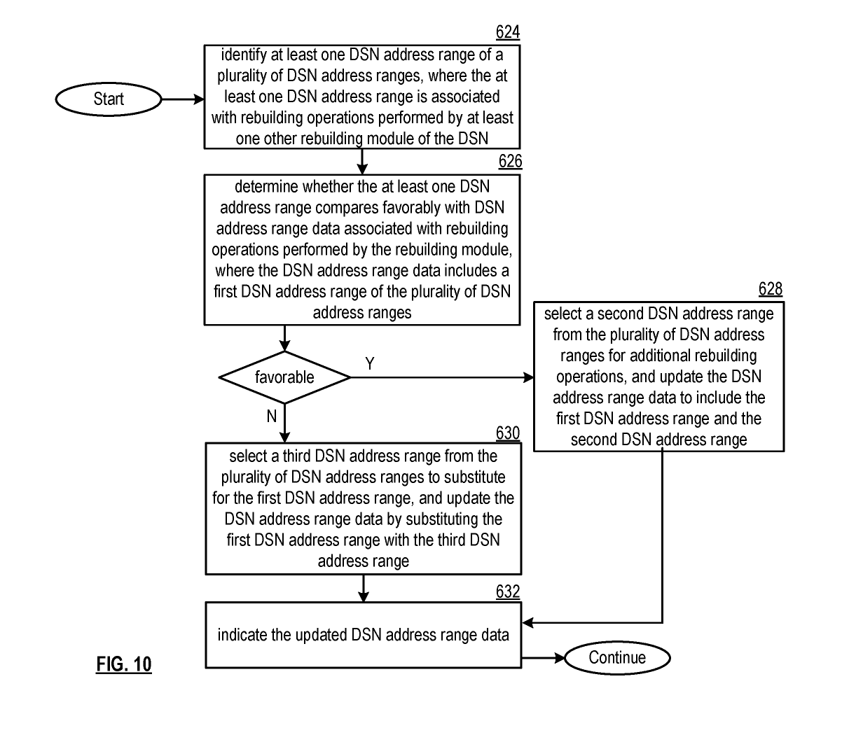

FIG. 9A is a schematic block diagram of another embodiment of a dispersed storage network (DSN) system that includes a storage unit set 386 and a rebuilding module 388. The rebuilding module 388 may be implemented using one or more of a computing device, a server, a user device, the integrity processing unit 20 FIG. 1, a storage integrity module, a dispersed storage (DS) processing unit, a DS processing module, a DS unit, a distributed storage and task (DST) processing module, the DST client module 34 of FIG. 1, the computing device 16 of FIG. 1, and/or the storage unit 36 of FIG. 1. The storage unit set 386 includes a set of storage units 354 that are utilized to store one or more sets of encoded data slices, where a data segment is encoded using a dispersed storage error coding function to produce the one or more sets of encoded data slices. Some or all storage units 354 can be implemented by utilizing storage unit 36 of FIG. 1. The system functions to remedy a storage error (e.g., missing encoded data slice, corrupted encoded data slice) associated with an encoded data slice stored within a storage unit 354 of the set of storage units. The rebuilding module 388 detects the storage error of the encoded data slice of a corresponding set of encoded data slices associated with the storage unit of the set of storage units. The detecting includes at least one of a scanning for storage errors, receiving an error message, and receiving a rebuilding request. The rebuilding module 388 selects a decode threshold number of storage units as rebuilding participants 390. The selecting includes identifying available storage units 354 of the set of storage units and selecting from the available storage units those storage units associated with other encoded data slices of the set of encoded data slices, where the other encoded data slices are not associated with storage errors.

The rebuilding module 388 issues partial slice requests 392 to each storage unit of the rebuilding participants 390, where each partial slice request 392 includes one or more of an identifier of the encoded data slice associated with the storage error, identifiers of the rebuilding participants, a rebuilding matrix, an encoding matrix, a public key of a public/private key pair of the rebuilding module, and a partial rebuild package routing ordering (e.g., including a destination for sending a partial rebuild package).

A rebuilding participant (e.g., hereafter interchangeably referred to as a storage unit 354), of the rebuilding participants 390, generates a zero information gain partial slice. The generating the zero information gain partial slice includes obtaining an encoding matrix utilized to generate the encoded data slice (e.g., extract from a received partial slice request, retrieve from a memory), reducing the encoding matrix to produce a square matrix that exclusively includes rows identified in the partial slice request (e.g., include a decode threshold number of rows associated with the rebuilding participants), inverting the square matrix to produce an inverted matrix (e.g., alternatively, may extract the rebuilding matrix from the partial slice request as the inverted matrix), matrix multiplying the inverted matrix by an associated encoded data slice held by the rebuilding participant (e.g., of the other encoded data slices of the set of encoded data slices) to produce a vector, and matrix multiplying the vector by a row of the encoding matrix corresponding to the encoded data slice to be rebuilt (e.g., alternatively, may extract the row from the partial slice request), to produce the zero information gain partial slice.

The rebuilding participant encrypts the zero information gain partial slice using the public key of the rebuilding module and a homomorphic encryption algorithm to produce an encrypted zero information gain partial slice. Homomorphic encryption enables operations to be performed on ciphertexts, which remain intact upon decryption. For example, if A and B are two plaintext numbers, an “additively” homomorphic encryption system is one in which Decryption(Encryption(A)+Encryption(B))=A+B. Examples include the Paillier cryptosystem and the Goldwasser—Micali cryptosystem. Thus, two encrypted ciphertexts can be added and when decrypted with the appropriate key, the result is the same as if plaintexts A and B had been added.

The rebuilding participants and/or the rebuilding module combines a corresponding encrypted zero information gain partial slice from each of the rebuilding participants to produce a partial rebuild package 394. The combining includes one or more of combining a received partial rebuild package 394 from another rebuilding participant with the encrypted zero information gain partial slice to produce another partial rebuild package and sending the other partial rebuild package 394 to yet another rebuilding participant in accordance with the partial rebuild package routing ordering. For example, a second storage unit of the rebuilding participants receives a partial rebuild package 394 from a first storage unit 354 of the rebuilding participants 390, combines the received partial rebuild package from the first storage unit with its own encrypted zero information gain partial slice to produce the other partial rebuild package 394 to send to a third storage unit 354 of the rebuilding participants 390.

The combining of the received partial rebuild package 394 from the other rebuilding participant with the encrypted zero information gain partial slice includes finding the sum of the partials in the field. For example, the received partial rebuild package is exclusiveOR-ed with the encrypted zero information gain partial. Depending on the field, summing may be exclusiveOR (XOR) or it may be another form of addition (e.g., such as addition modulo a prime). For example, some implementations of Shamir secret sharing, for example, perform all addition and multiplication modulo some prime. In such a case, instead of using XOR the summing may be accomplished by combining the partials via modular addition (e.g., which is how addition is defined in that field of integers). Such an approach may require a minor change to how the encryption of the partials works. Instead of combining the partial with a keystream via XOR, one rebuilding participant would add the key stream (e.g., according to rules of addition in the field) such that another rebuilding participant using a corresponding key would subtract the same keystream from a partial associated with the other rebuilding participant. In fields where XOR represents addition, it also represents subtraction, so all participants handle combining identically. In an alternate field of integers where addition was not identical to subtraction, then rebuilding participants must agree on a convention where a first rebuilding participant subtracts and a second rebuilding participant adds. For example, the convention may include a deterministic approach where whichever rebuilding participant has a lower index number for the encoded data slice/share they hold adds and another rebuilding participant associated with a higher index number subtracts.

A last storage unit 354 of the rebuilding participants 390 generates an output and associated partial rebuild package 394 as a rebuild package 396 to the rebuilding module 388, where the rebuild package 396 includes a combination of each of a decode threshold number of encrypted zero information gain partial slices from each of the rebuilding participants. The rebuilding module 388 decrypts the rebuild package 396 using a private key of the public/private key pair of the rebuilding module 388 to produce a rebuilt slice 398. The rebuilding module 388 facilitates storage of the rebuilt slice 398 in the storage unit 354 associated with the storage error. For example, the rebuilding module 388 sends the rebuilt slice 398 to a seventh storage unit 354 for storage.

FIG. 9B is a schematic block diagram of another embodiment of a dispersed storage network (DSN) system that includes a plurality of rebuilding modules 388 of FIG. 9A and the storage unit set 386 of Figure A. The storage unit set 386 includes a set of storage units 354 of FIG. 9A and are utilized to store one or more sets of shares and/or slices, where a data segment is encoded to produce the one or more sets of shares (e.g., or slices). Henceforth, share and slice may be used interchangeably.

In a DSN memory, multiple rebuild modules can perform rebuild operations at the same time. By utilizing parallelism, more favorable overall results can be obtained. In some cases, this can lead to problems, such as too many rebuild modules rebuilding data for the same storage unit, and/or too many rebuild modules rebuilding data for the same disk in the same storage unit. When such a problem occurs, a bottleneck may be reached that causes rebuilding to operate at a level slower than it otherwise is capable of Rebuild modules which run concurrently for a storage unit can become aware of the rebuilding activity of other rebuild modules through the ranges that are listed (scanned) by other rebuild modules, and/or by the reception of Read, Partial, or ZIG rebuild requests. Such requests can be indicated to all the involved parties for which slices are being rebuilt. Since rebuilding is typically slower than scanning, when a memory device fails, many rebuild modules may end up focusing on the same storage unit or even the same memory device of a storage unit. To avoid congestion, rebuilding entities may skip a great enough distance within the namespace with a high probability, to help ensure that rebuild activity will fall on a different memory device (or a different storage unit) compared to the determined activity of other rebuild modules. If only a single failure or small number of failures is known, and a sufficient number of rebuild modules are concurrently addressing it, other rebuild modules that detect this situation can fall back to perform scanning instead of rebuilding, and/or defer their rebuilding activity to a later time.

The plurality of rebuilding modules 388 are operable to share rebuilding responsibilities of scanning the storage unit set 386 to detect storage errors associated with the one or more sets of slices and facilitating abatement of detected storage errors by rebuilding one or more slices associated with the detected storage errors. From time to time, the responsibilities may overlap from storage unit the storage unit. For example, two or more of the rebuilding modules 388 may scan for the storage errors and produce a rebuilt slice that is associated with the detected storage errors for slices associated with a common dispersed storage network (DSN) address range. Each slice is associated with a DSN address (e.g., a slice name), where slices of a set of slices share a common component of a set of DSN addresses associated with the set of shares. For example, a set of shares are associated with a set of slice names, where each slice name of the set of slice names includes a common source name.

To facilitate execution of the rebuilding responsibilities, each rebuilding module 388 can issue and/or receive rebuilding requests 620 with the set of storage units and another one or more rebuilding modules 388. The rebuilding requests 620 can include one or more of a list slice request, a list digest of a slice list request, a read slice request, a generate partially encoded slice request, a zero information gain rebuilding request, and/or a slice rebuilding request. Each rebuilding module 388 can receive rebuilding responses 622 associated with the rebuilding responsibilities. The rebuilding responses 622 can include one or more of a list slice response, a list digest of a slice list response, a read slice response a generate partially encoded slice response, a zero information gain rebuilding response, and/or a slice rebuilding response.

A rebuilding module 388 can identify one or more DSN address ranges associated with rebuilding operations performed by one or more of the rebuilding modules 388. The identifying can include at least one of receiving a rebuilding DSN address range message, and extracting a DSN address from a received rebuilding request, interpreting a rebuilding schedule, and/or receiving an error message. The rebuilding module 388 can compare the one or more DSN address ranges to a current DSN address range associated with rebuilding operations performed by the rebuilding module 388 (e.g., to check for DSN address range rebuilding activities overlap). When the comparison is unfavorable (e.g., DSN address range rebuilding activity overlap greater than a high overlap threshold), the rebuilding module 388 can select another DSN address range to substitute for a DSN address range associated with the unfavorable comparison. For example, the rebuilding module 388 eliminates at least one DSN address range associated with the rebuilding operations performed by the rebuilding module 388. When the comparison is favorable (e.g., DSN address range rebuilding activity overlap is less than a low overlap threshold), the rebuilding module 388 can select an additional DSN address range for additional rebuilding operations. The selecting can include identifying the additional DSN address range such that the additional DSN address range has minimal overlap with other DSN address ranges of other rebuilding modules. The selecting can further include the rebuilding module queuing rebuilding tasks associated with the additional DSN address range.

The rebuilding module 388 can update the current DSN address range associated with rebuilding operations performed by the rebuilding module 388 to include the additional DSN address range. The rebuilding module 388 can indicate the current DSN address range with at least some of the one or more other rebuilding modules 388. The indicating can include at least one of performing rebuilding operations and/or issuing an updated DSN address range message that includes the current DSN address range.

In various embodiments, a processing system of a rebuilding module of a DSN that includes at least one processor and a memory that stores operational instructions, that when executed by the at least one processor, cause the processing system to identify at least one DSN address range of a plurality of DSN address ranges, where the at least one DSN address range is associated with rebuilding operations performed by at least one other rebuilding module of the DSN. The processing system determines whether the at least one DSN address range compares favorably with DSN address range data associated with rebuilding operations performed by the rebuilding module, where the DSN address range data includes a first DSN address range of the plurality of DSN address ranges. When the at least one DSN address range compares favorably with the DSN address range data, a second DSN address range is selected from the plurality of DSN address ranges for additional rebuilding operations, and the DSN address range data is updated to include the first DSN address range and the second DSN address range. When the at least one DSN address range compares unfavorably with the first DSN address range, a third DSN address range is selected from the plurality of DSN address ranges to substitute for the first DSN address range, and the DSN address range data is updated by substituting the first DSN address range with the third DSN address range. The updated DSN address range data is indicated.

In various embodiments, the rebuilding operations performed by the rebuilding module include rebuilding at least one encoded data slice of a set of encoded data slices associated with a data segment associated with a detected storage error, and where the data segment was dispersed storage error encoded to produce the set of encoded data slices for storage in a set of storage units associated with the plurality of DSN address ranges. In various embodiments, identifying the at least one DSN address range includes extracting at least one DSN address from a received rebuilding request. In various embodiments, determining whether the at least one DSN address range compares favorably with the DSN address range data includes determining an amount of overlap in DSN address range building activities between the at least one DSN address range and the first DSN address range, and further includes comparing the amount of overlap to a high overlap threshold.

In various embodiments, selecting the second DSN address range includes determining that the second DSN address range has a minimum overlap with the at least one DSN address range. In various embodiments, selecting the second DSN address range includes queuing rebuilding tasks associated with the second DSN address range. In various embodiments, selecting the third DSN address range includes determining that the third DSN address range is not included in the at least one DSN address range.

In various embodiments, indicating the updated DSN address range data includes issuing an updated DSN address range message that includes the updated DSN address range data. In various embodiments, rebuilding operations associated with the updated DSN address range data are performed.

FIG. 10 is a flowchart illustrating an example of managing rebuilding performance. In particular, a method is presented for use in association with one or more functions and features described in conjunction with FIGS. 1-9B, for execution by a processing system of a rebuilding module that includes a processor or via another processing system of a dispersed storage network that includes at least one processor and memory that stores instruction that configure the processor or processors to perform the steps described below.

The method begins at step 624 where a processing system (e.g., of a rebuilding module) identifies at least one DSN address range of a plurality of DSN address ranges, where the at least one DSN address range is associated with rebuilding operations performed by at least one other rebuilding module of the DSN. The method continues at step 626 where the processing system determines whether the at least one DSN address range compares favorably with DSN address range data associated with rebuilding operations performed by the rebuilding module, where the DSN address range data includes a first DSN address range of the plurality of DSN address ranges. The method branches to step 630 when the comparison is unfavorable. The method continues to step 628 when the comparison is favorable.

Step 628 includes selecting a second DSN address range from the plurality of DSN address ranges for additional rebuilding operations, and updating the DSN address range data to include the first DSN address range and the second DSN address range, when the comparison is favorable. The selecting includes identifying an open DSN address range (e.g., no rebuilding modules are responsible for the open DSN address range) as the second DSN address range and queuing additional rebuilding tasks for the second DSN address range. The updating can include modifying the DSN address range in accordance with the first DSN address range and the second DSN address ranges and/or additional DSN address ranges. The method then branches to step 632.

The method continues at step 630 when the comparison is unfavorable, where the processing system selects a third DSN address range from the plurality of DSN address ranges to substitute for the first DSN address range, and updates the DSN address range data by substituting the first DSN address range with the third DSN address range. The selecting can include one or more of adding a DSN address range offset to a currently active DSN address range within an overall allowable rebuilding DSN address range, selecting the third DSN address range when the third DSN address range is associated with a memory device that is not associated with the currently active at least one DSN address range, and/or restricting issuing rebuilding requests in favor of issuing scanning requests when selection of the third DSN address range is not practical. The updating can include modifying the DSN address range in accordance with removing the first DSN address range and including the third DSN address range.

The method continues at step 632 where the processing system indicating the updated DSN address range data. The indicating includes performing rebuilding operations and issuing a rebuilding DSN address range message to one or more other rebuilding modules.

In various embodiments, the rebuilding operations performed by the rebuilding module include rebuilding at least one encoded data slice of a set of encoded data slices associated with a data segment associated with a detected storage error, and where the data segment was dispersed storage error encoded to produce the set of encoded data slices for storage in a set of storage units associated with the plurality of DSN address ranges. In various embodiments, identifying the at least one DSN address range includes extracting at least one DSN address from a received rebuilding request. In various embodiments, determining whether the at least one DSN address range compares favorably with the DSN address range data includes determining an amount of overlap in DSN address range building activities between the at least one DSN address range and the first DSN address range, and further includes comparing the amount of overlap to a high overlap threshold.

In various embodiments, selecting the second DSN address range includes determining that the second DSN address range has a minimum overlap with the at least one DSN address range. In various embodiments, selecting the second DSN address range includes queuing rebuilding tasks associated with the second DSN address range. In various embodiments, selecting the third DSN address range includes determining that the third DSN address range is not included in the at least one DSN address range.

In various embodiments, indicating the updated DSN address range data includes issuing an updated DSN address range message that includes the updated DSN address range data. In various embodiments, rebuilding operations associated with the updated DSN address range data are performed.

In various embodiments, a non-transitory computer readable storage medium includes at least one memory section that stores operational instructions that, when executed by a processing system of a dispersed storage network (DSN) that includes a processor and a memory, causes the processing system to identify at least one DSN address range of a plurality of DSN address ranges, where the at least one DSN address range is associated with rebuilding operations performed by at least one rebuilding module of the DSN. The processing system determines whether the at least one DSN address range compares favorably with DSN address range data associated with performed rebuilding, where the DSN address range data includes a first DSN address range of the plurality of DSN address ranges. When the at least one DSN address range compares favorably with the DSN address range data, a second DSN address range is selected from the plurality of DSN address ranges for additional rebuilding operations, and the DSN address range data is updated to include the first DSN address range and the second DSN address range. When the at least one DSN address range compares unfavorably with the first DSN address range, a third DSN address range is selected from the plurality of DSN address ranges to substitute for the first DSN address range, and the DSN address range data is updated by substituting the first DSN address range with the third DSN address range. The updated DSN address range data is indicated.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing system”, “processing module”, “processing circuit”, “processor”, and/or “processing unit” may be used interchangeably, and may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing system, processing module, module, processing circuit, and/or processing unit may be, or further include, memory and/or an integrated memory element, which may be a single memory device, a plurality of memory devices, and/or embedded circuitry of another processing system, processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing system, processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing system, processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing system, processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a rebuilding module of a dispersed storage network (DSN) that includes a processor, the method comprises:
identifying at least one DSN address range of a plurality of DSN address ranges, wherein the at least one DSN address range is associated with rebuilding operations performed by at least one other rebuilding module of the DSN;
determining whether the at least one DSN address range compares favorably with DSN address range data associated with rebuilding operations performed by the rebuilding module, wherein the DSN address range data includes a first DSN address range of the plurality of DSN address ranges;
selecting a second DSN address range from the plurality of DSN address ranges for additional rebuilding operations, and updating the DSN address range data to include the first DSN address range and the second DSN address range, when the at least one DSN address range compares favorably with the DSN address range data;
selecting a third DSN address range from the plurality of DSN address ranges to substitute for the first DSN address range, and updating the DSN address range data by substituting the first DSN address range with the third DSN address range, when the at least one DSN address range compares unfavorably with the first DSN address range; and
indicating the updated DSN address range data.

2. The method of claim 1, wherein the rebuilding operations performed by the rebuilding module include rebuilding at least one encoded data slice of a set of encoded data slices associated with a data segment associated with a detected storage error, and wherein the data segment was dispersed storage error encoded to produce the set of encoded data slices for storage in a set of storage units associated with the plurality of DSN address ranges.

3. The method of claim 1, wherein identifying the at least one DSN address range includes extracting at least one DSN address from a received rebuilding request.

4. The method of claim 1, wherein determining whether the at least one DSN address range compares favorably with the DSN address range data includes determining an amount of overlap in DSN address range building activities between the at least one DSN address range and the first DSN address range, and further includes comparing the amount of overlap to a high overlap threshold.

5. The method of claim 1, wherein selecting the second DSN address range includes determining that the second DSN address range has a minimum overlap with the at least one DSN address range.

6. The method of claim 1, wherein selecting the second DSN address range includes queuing rebuilding tasks associated with the second DSN address range.

7. The method of claim 1, wherein selecting the third DSN address range includes determining that the third DSN address range is not included in the at least one DSN address range.

8. The method of claim 1, wherein indicating the updated DSN address range data includes issuing an updated DSN address range message that includes the updated DSN address range data.

9. The method of claim 1, further comprising performing rebuilding operations associated with the updated DSN address range data.

10. A processing system of a rebuilding module comprises:
at least one processor;
a memory that stores operational instructions, that when executed by the at least one processor cause the processing system to:
identify at least one DSN address range of a plurality of DSN address ranges, wherein the at least one DSN address range is associated with rebuilding operations performed by at least one other rebuilding module of a DSN that includes the rebuilding module;
determine whether the at least one DSN address range compares favorably with DSN address range data associated with rebuilding operations performed by the rebuilding module, wherein the DSN address range data includes a first DSN address range of the plurality of DSN address ranges;
select a second DSN address range from the plurality of DSN address ranges for additional rebuilding operations, and update the DSN address range data to include the first DSN address range and the second DSN address range, when the at least one DSN address range compares favorably with the DSN address range data;
select a third DSN address range from the plurality of DSN address ranges to substitute for the first DSN address range, and update the DSN address range data by substituting the first DSN address range with the third DSN address range, when the at least one DSN address range compares unfavorably with the first DSN address range; and
indicate the updated DSN address range data.

11. The processing system of claim 10, wherein the rebuilding operations performed by the rebuilding module include rebuilding at least one encoded data slice of a set of encoded data slices associated with a data segment associated with a detected storage error, and wherein the data segment was dispersed storage error encoded to produce the set of encoded data slices for storage in a set of storage units associated with the plurality of DSN address ranges.

12. The processing system of claim 10, wherein identifying the at least one DSN address range includes extracting at least one DSN address from a received rebuilding request.

13. The processing system of claim 10, wherein determining whether the at least one DSN address range compares favorably with the DSN address range data includes determining an amount of overlap in DSN address range building activities between the at least one DSN address range and the first DSN address range, and further includes comparing the amount of overlap to a high overlap threshold.

14. The processing system of claim 10, wherein selecting the second DSN address range includes determining that the second DSN address range has a minimum overlap with the at least one DSN address range.

15. The processing system of claim 10, wherein selecting the second DSN address range includes queuing rebuilding tasks associated with the second DSN address range.

16. The processing system of claim 10, wherein selecting the third DSN address range includes determining that the third DSN address range is not included in the at least one DSN address range.

17. The processing system of claim 10, wherein indicating the updated DSN address range data includes issuing an updated DSN address range message that includes the updated DSN address range data.

18. The processing system of claim 10, wherein the operational instructions, when executed by the at least one processor, further cause the processing system to perform rebuilding operations associated with the updated DSN address range data.

19. A computer readable storage medium comprises:
at least one memory section that stores operational instructions that, when executed by a processing system of a dispersed storage network (DSN) that includes a processor and a memory, causes the processing system to:
identify at least one DSN address range of a plurality of DSN address ranges, wherein the at least one DSN address range is associated with rebuilding operations performed by at least one rebuilding module of the DSN;
determine whether the at least one DSN address range compares favorably with DSN address range data associated with performed rebuilding operations, wherein the DSN address range data includes a first DSN address range of the plurality of DSN address ranges;
select a second DSN address range from the plurality of DSN address ranges for additional rebuilding operations, and update the DSN address range data to include the first DSN address range and the second DSN address range, when the at least one DSN address range compares favorably with the DSN address range data;
select a third DSN address range from the plurality of DSN address ranges to substitute for the first DSN address range, and update the DSN address range data by substituting the first DSN address range with the third DSN address range, when the at least one DSN address range compares unfavorably with the first DSN address range; and
indicate the updated DSN address range data.

20. The computer readable storage medium of claim 19, wherein the performed rebuilding operations include rebuilding at least one encoded data slice of a set of encoded data slices associated with a data segment associated with a detected storage error, and wherein the data segment was dispersed storage error encoded to produce the set of encoded data slices for storage in a set of storage units associated with the plurality of DSN address ranges.
